(19) United States
(12) Patent Application Publication
(10) Pub. No.: US 2018/0121830 A1
(43) Pub. Date: May 3, 2018

(54) SYSTEMS AND METHODS FOR CLASSIFICATION OF COMMENTS FOR PAGES IN SOCIAL NETWORKING SYSTEMS

(71) Applicant: Facebook, Inc., Menlo Park, CA (US)

(72) Inventors: Matthew Logan Schmid, New York, NY (US); Ehud Weinsberg, Menlo Park, CA (US)

(21) Appl. No.: 15/342,069

(22) Filed: Nov. 2, 2016

(51) Int. Cl. G06N 99/00; G06Q 50/00

(52) U.S. Cl. CPC G06N 99/005; G06Q 50/01

(57) ABSTRACT

Systems, methods, and non-transitory computer-readable media according to certain aspects can obtain a comment submitted by a user on a page associated with an entity. A training data set, including a plurality of comments, that indicates whether each of the plurality of comments is actionable can be determined. A machine learning model can be trained based on the training data set. Whether the comment is actionable can be determined based at least in part on the machine learning model.

### FIELD OF THE INVENTION

The present technology relates to the field of social networks. More particularly, the present technology relates to processing of comments in social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be given the opportunity to interact with profiles or pages on the social networking system that are associated with other users or entities. The profiles and the pages can be dedicated locations on the social networking system to reflect the presence of the other users and entities on the social networking system. A user can interact with the profiles and the pages in a variety of manners. For example, a user can send a message to a page associated with a business or comment on posts on the page.

### SUMMARY

Various embodiments of the present disclosure can include systems, methods, and non-transitory computer readable media configured to obtain a comment submitted by a user on a page associated with an entity. A training data set, including a plurality of comments, that indicates whether each of the plurality of comments is actionable can be determined. A machine learning model can be trained based on the training data set. Whether the comment is actionable can be determined based at least in part on the machine learning model.

In some embodiments, the determining whether the comment is actionable comprises associating the comment with a first classification in response to determining that the comment is actionable, where the first classification is indicative of a comment being actionable.

In certain embodiments, the machine learning model provides the first classification and a confidence score associated with the first classification.

In an embodiment, the first classification is associated with the comment when the confidence score associated with the first classification satisfies a threshold value.

In some embodiments, the first classification is displayed in a user interface associated with the page when the confidence score associated with the first classification satisfies a threshold value.

In certain embodiments, user input relating to whether the first classification is correct is received.

In an embodiment, a comment that is actionable in the training data set is associated with the first classification.

In some embodiments, the determining the training data set comprises performing a pattern search on one or more comments using one or more regular expressions, wherein each of the one or more regular expressions is associated with the first classification, and wherein a comment of the one or more comments that includes text matching at least one of the one or more regular expressions is associated with the first classification and included in the training data set.

In certain embodiments, the determining the training data set comprises obtaining one or more comments that are associated with the first classification based at least in part on human input.

In an embodiment, an intent classification for the comment can be determined, where the intent classification is indicative of an intent associated with a comment.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a comment ranking module configured to determine a classification for comments for pages, according to an embodiment of the present disclosure.

FIG. 2 illustrates an example comment classification module configured to classify comments for pages, according to an embodiment of the present disclosure.

FIG. 3 illustrates an example user interface for providing comments and associated classifications, according to an embodiment of the present disclosure.

FIG. 4 illustrates an example first method for determining classification for comments for pages, according to an embodiment of the present disclosure.

FIG. 5 illustrates an example second method for determining classification for comments for pages, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Classification of Comments for Pages in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a social networking system (e.g., a social networking service, a social network, etc.). The social networking system can allow the users, for example, to add connections, or post content items.

The social networking system may provide pages for various entities. For example, pages may be associated with companies, businesses, brands, products, artists, public figures, entertainment, individuals, and other types of entities. The pages can be dedicated locations on the social networking system to reflect the presence of the entities on the social networking system. The pages can publish content that is deemed relevant to the associated entities to promote interaction with the pages. In this regard, users can interact with the pages. For example, users may send messages to pages, and page administrators can review and process the messages. In one example, users can send messages to a page for a business regarding various products and services offered by the business. Users can also comment on content on pages. For example, users can submit a comment on a post on a page. In some cases, page administrators may review and process comments on pages.

In many cases, conventional approaches specifically arising in the realm of computer technology may provide comments submitted by users on pages without further computer processing to determine whether action needs to be taken with respect to certain comments. In general, comments on pages may not require any action by page administrators. But some comments can require action by page administrators. For example, a comment can inquire about products, services, customer service, jobs, etc. in connection with a page, and a page administrator may wish to respond to such a comment. However, conventional approaches may not provide any guidelines or indications as to which comments should be prioritized. A page can receive a large number of comments on a given day, and a page administrator may be left with the daunting task of sorting through and determining whether to respond to certain comments. Further, when the amount of comments is large, page administrators may be prevented from appropriately identifying and responding to comments that are relatively more urgent or that require action on their part. The challenge in processing the comments is based in large part on the inability of page administrators to readily access information relating to whether the comments require action or not.

An improved approach rooted in computer technology can overcome the foregoing and other disadvantages associated with conventional approaches specifically arising in the realm of computer technology. Based on computer technology, the disclosed technology can classify comments based on whether action needs to be taken in connection with the comments. A comment that requires action by a page administrator can be referred to as an “actionable comment,” and a comment that does not require action by the page administrator can be referred to as a “non-actionable comment.” The disclosed technology can classify comments as actionable comments and non-actionable comments. An actionable comment can be associated with an “actionable” classification. Similarly, a non-actionable comment can be associated with a “non-actionable” classification. The “actionable” classification or the “non-actionable” classification can constitute an “action classification.” In some embodiments, a comment can be associated with an intent classification, in addition to or instead of an action classification. An intent classification can indicate an intent or purpose associated with a comment. For example, an intent or purpose associated with a comment can be to complain, compliment, etc.

Accordingly, a comment can be associated with one or more classifications. One or more classifications associated with a comment can be provided to a page administrator through a user interface associated with a page. A machine learning model can be used in determining classifications associated with comments. The machine learning model can be trained based on a training data set including a plurality of comments. The training data set can indicate a classification (e.g., “actionable” or “non-actionable”) for each of the plurality of comments. The machine learning model can provide a confidence level regarding a determination of a classification associated with a comment. In certain cases, the classifications associated with comments are provided to page administrators only if they meet a particular confidence level. In this way, the disclosed technology can provide information relating to whether comments require action by page administrators and/or information relating to an intent or purpose associated with comments. Such information can be used to determine how to process or prioritize the comments.

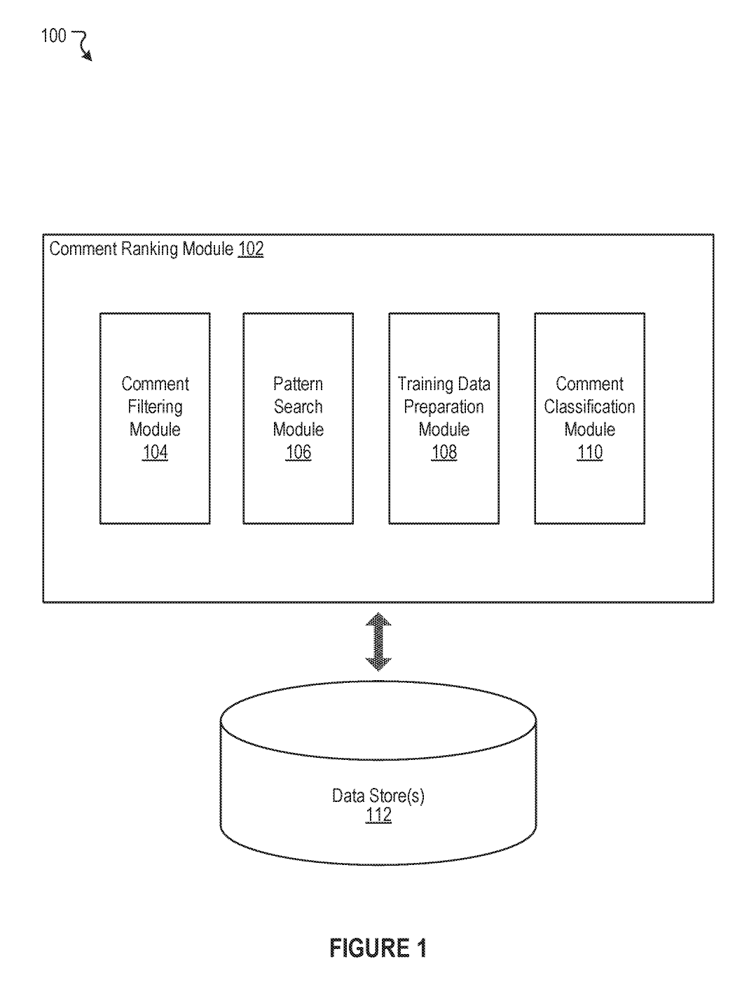

FIG. 1 illustrates an example system 100 including an example comment ranking module 102 configured to determine a classification for a comment for a page, according to an embodiment of the present disclosure. In contrast to comments, messages sent to pages associated with entities often require action. A message can be a private communication only addressed to and accessible by an entity associated with a page. A page administrator can operate on an assumption that messages should be reviewed and processed. On the other hand, most comments submitted on pages may not require action. A comment can be associated with a post on a page and can be accessible to the public or other users. In many cases, a page administrator may not need to review or process a comment. However, some comments can include content that is similar to content in messages and thus can require action. For example, certain comments can inquire about products or services provided by an entity associated with a page. Accordingly, providing an indication of whether a comment is actionable or not can be helpful to page administrators. As mentioned above, a comment can be associated with an action classification, such as the “actionable” classification or the “non-actionable” classification. A machine learning model can be used in classifying a comment based on action classifications. In some embodiments, the comment ranking module 102 can only define the “actionable” classification, and not the “non-actionable” classification. In such embodiments, actionable comments can be associated with the “actionable” classification, and non-actionable comments can be not associated with the “actionable” classification. Page administrators can refer to action classifications associated with comments to recognize which comments can require action and process the comments accordingly.

In certain embodiments, the comment ranking module 102 can associate a comment with one or more classifications other than action classifications. For example, a comment can be classified according to an intent or purpose associated with a comment. Examples of an intent or purpose associated with a comment can include complaint, compliment, etc. The comment ranking module 102 can define a classification associated with an intent or purpose associated with a comment. As mentioned above, such a classification can be referred to as an intent classification. For example, the comment ranking module 102 can define a “complaint” intent classification, a “compliment” intent classification, etc. The comment ranking module 102 can classify comments according to intent classifications in addition to classifying the comments based on action classifications. For example, comments that are classified as actionable can be further classified according to one or more intent classifications. In some cases, the comment ranking module 102 can classify comments according to intent classifications without first classifying the comments based on action classifications. In such cases, comments that are associated with intent classifications can be determined to be actionable. A machine learning model can be used in classifying comments based on intent classifications. Determining one or more classifications associated with a comment is explained in more detail below.

The examples described herein in connection with comments submitted on pages are for illustrative purposes, but the techniques described in this disclosure may also be applicable to any type of comments submitted via any system involving communication, including but not limited to a social networking system. Classification information can be helpful to users other than page administrators and can also be utilized by such users. In addition, the techniques described in this disclosure may be used with different languages. There can be many variations and possibilities.

As shown in the example of FIG. 1, the comment ranking module 102 can include a comment filtering module 104, a pattern search module 106, a training data preparation module 108, and a comment classification module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

The comment filtering module 104 can be configured to filter comments prior to classifying the comments as actionable or non-actionable. For example, the comment filtering module 104 can filter comments that are unlikely to be actionable. In some embodiments, the comment filtering module 104 can filter comments based on a length of text included in the comments. Comments having short lengths of text (e.g., greetings) are unlikely to be actionable, and the comment filtering module 104 can filter a comment when a length of text included in the comment falls below a threshold. In certain embodiments, the comment filtering module 104 can filter comments based on whether comments are similar to messages. Since messages are more likely to require action by page administrators, the comment filtering module 104 can classify comments as comments that are similar to messages and comments that are not similar to messages. Comments that are similar to messages can be classified as actionable or non-actionable. Comments that are not similar to messages can be filtered out without being classified as actionable or non-actionable. For example, the comment filtering module 104 can define a “similar to message” classification and a “not similar to message” classification, which can be referred to as “message similarity classifications.” The comment filtering module 104 can classify comments based on message similarity classifications. A machine learning model can be used in classifying comments based on message similarity classifications. In some embodiments, the comment filtering module 104 can only define the “similar to message” classification, and not the “not similar to message” classification. In such embodiments, comments that are similar to messages can be associated with the “similar to message” classification, and comments that are not similar to messages can be not associated with the “similar to message” classification. In some embodiments, the comment filtering module 104 can determine whether comments are similar to messages based on the content of the comments, for example, using a pattern search with regular expressions, as explained below.

In certain embodiments, the comment filtering module 104 can be configured to filter comments prior to classifying the comments based on intent classifications. As explained above, comments can be classified based on intent classifications without first being classified based on action classifications. If comments are classified based on intent classifications without first being classified based on action classifications, the comment filtering module 104 can filter the comments prior to classifying the comments based on the intent classifications. As explained above, the comment filtering module 104 can classify comments based on message similarity classifications.

The pattern search module 106 can be configured to perform a pattern search or pattern matching on comments submitted to pages. The pattern search can be used to identify classifications for comments to be included in a training data set. The pattern search can be performed on the text of the comments using regular expressions. In certain embodiments, a regular expression may refer to a sequence of characters that define a search pattern for use in pattern matching with strings or string matching. Each character in a regular expression can be a metacharacter (e.g., “?”, “*”, etc.) or a regular character (e.g., “a”-“z”, etc.). A metacharacter can have a special meaning, and a regular or ordinary character can have its literal meaning. Metacharacters and regular characters can be used to identify textual material of a given pattern or to process a number of instances of the pattern. Pattern matches may vary from a precise equality to a very general similarity, depending on the metacharacters.

The pattern search module 106 can perform a pattern search to determine whether the text of a comment matches one or more regular expressions. Each regular expression may be associated with a classification, such as an action classification, an intent classification, etc. If the text of a comment matches a regular expression, then the pattern search module 106 can label the comment with the classification associated with the regular expression. One or more comments for which the classification is identified using pattern search can be included in a training data set to train a machine learning model for identifying classifications.

Regular expressions can be identical to, similar to, or otherwise indicative of the classification to which they relate. A regular expression can be based on a word, a phrase, or a sentence. For example, for the “actionable” classification, a regular expression can be defined based on the word “today,” the phrase “what is,” etc. A comment that includes one or more strings having text that match the regular expression can be assigned the “actionable” classification. Multiple regular expressions may be used to identify the same classification; for example, each of the multiple regular expressions can be associated with or mapped to the same classification. In the examples above, both the regular expression based on the word “today” and the regular expression based on the phrase “what is” can be associated with the “actionable” classification.

The pattern search module 106 can assign one or more classifications to comments based on regular expressions associated with the classifications. For example, if a comment matches two or more regular expressions associated with one classification, then the classification may be assigned to the comment. As another example, if a comment matches two or more regular expressions associated with two or more classifications, then the two or more classifications may be assigned to the comment.

The pattern search module 106 can allow regular expressions to be adjusted appropriately in order to obtain desired results. Often there can be a tradeoff between accuracy and coverage for a regular expression. If a regular expression associated with a classification is broader, it can cover or have many matching comments, but may also identify comments that are not highly related to the classification. On the other hand, if a regular expression is narrower, it may identify comments that are highly related to the classification, but may not include all comments that may match the classification. Regular expressions can be edited or modified to achieve the desired balance between accuracy and coverage. For example, if a particular classification assigned to a comment does not seem to accurately reflect actionability of the comment or an intent associated with the comment, regular expressions may be changed to achieve higher precision and reduce noise. In some embodiments, adjustments to regular expressions performed by the pattern search module 106 can be based on manual or machine learning techniques.

The training data preparation module 108 can be configured to compile and prepare a training data set to train a machine learning model. The training data set can include some or all comments submitted on selected pages and their associated classifications. The comments in the training data set may be selected randomly or based on any suitable criteria.

As explained above, the training data set can include comments that are labeled by the pattern search module 106 with classifications using pattern search. In some instances, it may be difficult to identify a classification for all comments using pattern search. For example, it may be challenging to define regular expressions that can identify all or most of actionable comments. Therefore, in certain cases, a person can manually review a comment to assign an appropriate classification. The training data preparation module 108 accordingly can include in the training data set comments that have been labeled with classifications based on manual review. In certain embodiments, selected comments may be labeled with classifications using pattern search first, and any comments that have not been labeled through the pattern search can be labeled based on manual review.

The training data preparation module 108 can adjust the number of different classifications included in the training data set to obtain desired results. For example, for broad coverage of a relatively large number of intents, a large number of classifications may be used. For narrower or more focused coverage of a relatively small number of intents, a fewer number of classifications may be used. In certain embodiments, a specific classification may be divided into subcategories. For instance, in an example relating to a page associated with a business, the “complaint” classification can be divided into subcategories of classifications for complaints relating to different products carried by the business, subcategories of classifications for different types of complaints, etc.

The comment classification module 110 can be configured to train a machine learning model and identify classifications for various comments. The comment classification module 110 can train the machine learning model based on a training data set provided by the training data preparation module 108. Once trained, the machine learning model can be applied to comments submitted to pages in order to identify one or more possible classifications for the comments. The comment classification module 110 is discussed in greater detail herein.

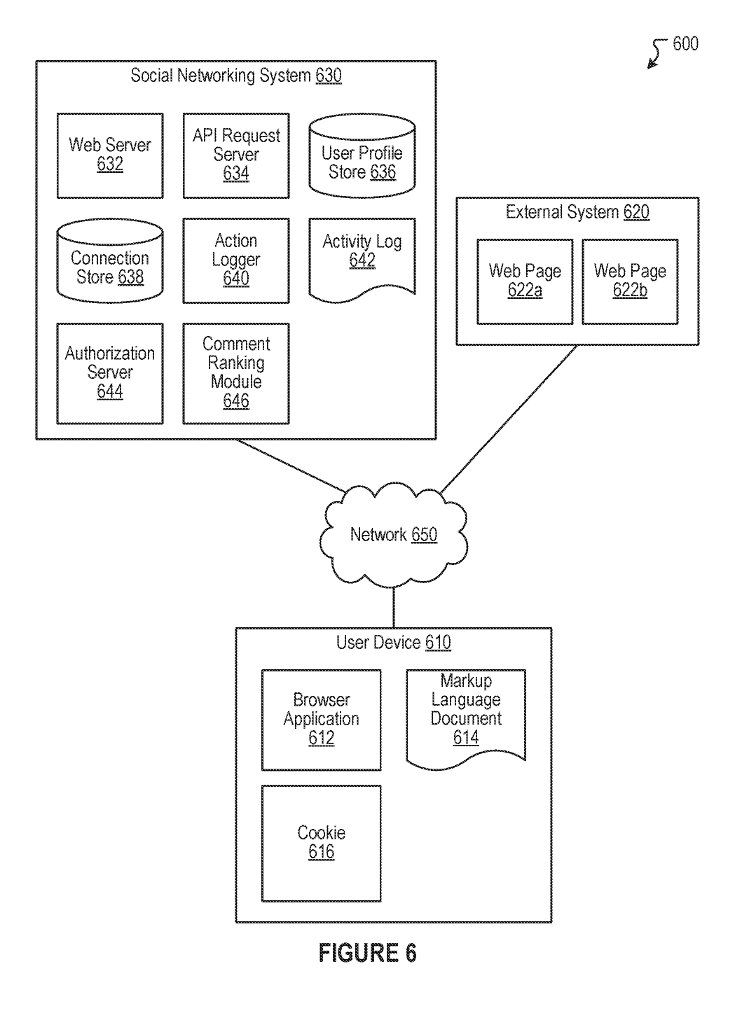

The comment ranking module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the comment ranking module 102 can be implemented, in part or in whole, as software running on one or more computing devices or systems, such as on a server computing system or a user (or client) computing system. For example, the comment ranking module 102 or at least a portion thereof can be implemented as or within an application (e.g., app), a program, or an applet, etc., running on a user computing device or a client computing system, such as the user device 610 of FIG. 6. In another example, the comment ranking module 102 or at least a portion thereof can be implemented using one or more computing devices or systems that include one or more servers, such as network servers or cloud servers. In some instances, the comment ranking module 102 can, in part or in whole, be implemented within or configured to operate in conjunction with a social networking system (or service), such as the social networking system 630 of FIG. 6. It should be understood that there can be many variations or other possibilities.

The comment ranking module 102 can be configured to communicate and/or operate with the at least one data store 112, as shown in the example system 100. The data store 112 can be configured to store and maintain various types of data. In some implementations, the data store 112 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user locations, user specified settings, content produced or posted by users, and various other types of user data. In some embodiments, the data store 112 can store information that is utilized by the comment ranking module 102. For example, the data store 112 can store data relating to pages, comments submitted on pages, regular expressions, training data sets including comments labeled with classifications, machine learning models, classifications, and the like. It is contemplated that there can be many variations or other possibilities.

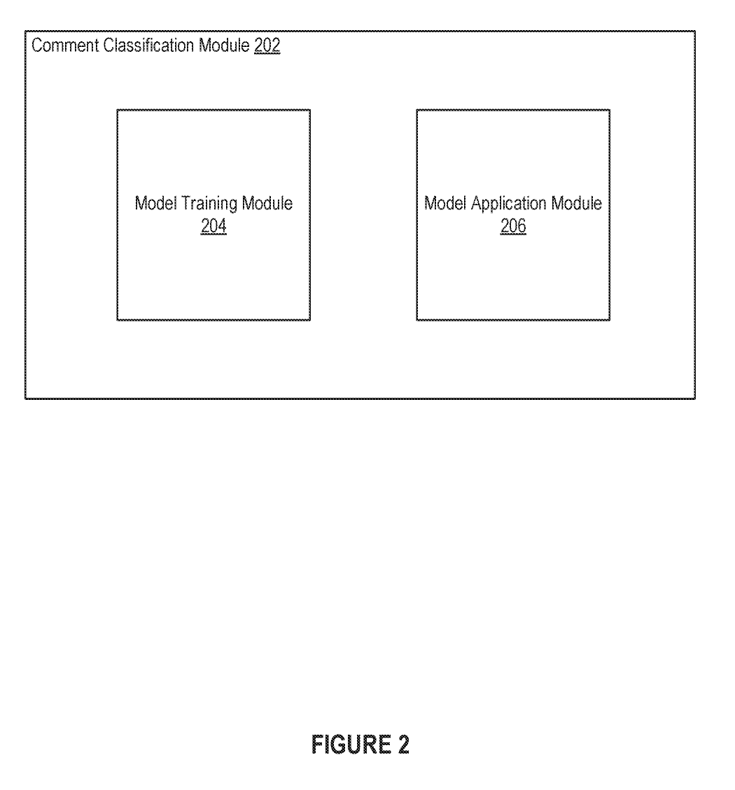

FIG. 2 illustrates an example comment classification module 202 configured to classify comments for pages, according to an embodiment of the present disclosure. In some embodiments, the comment classification module 110 of FIG. 1 can be implemented as the example comment classification module 202. As shown in FIG. 2, the comment classification module 202 can include a model training module 204 and a model application module 206.

The model training module 204 can be configured to train one or more machine learning models based on a training data set. The machine learning models can be trained, using the training data set, to identify one or more possible classifications for comments. In some embodiments, the machine learning models may be classifiers. The model training module 204 can train the machine learning models based on any suitable machine learning technique. In some embodiments, a suitable machine learning technique can include artificial neural networks, such as deep neural networks. A suitable machine learning technique can also include embedding and clustering. In some embodiments, the machine learning techniques can be supervised or at least partially supervised. In other instances, the machine learning techniques can be at least partially unsupervised. The machine learning models may be configured to output one or more potential classifications for each comment. The one or more classifications can be selected from the classifications that are included in the training data set.

In some embodiments, the machine learning models may also output a confidence score associated with a classification. For example, the confidence score can indicate a probability of an identified action classification accurately reflecting actionability of a comment or a probability of an identified intent classification accurately reflecting an intent associated with a comment. For instance, if a machine learning model determines a classification for a comment, then the machine learning model can determine a confidence score for the classification. As another example, if the machine learning model determines a list of classifications, the machine learning model can determine a confidence score for each classification in the list.

The model application module 206 can be configured to identify one or more possible classifications associated with a comment based on the trained machine learning models. The model application module 206 can apply one or more trained machine learning models to comments submitted on pages. As explained above, for each comment, a machine learning model can determine one or more classifications and a confidence score associated with the one or more classifications. In some embodiments, if the machine learning model outputs more than one possible classification for a particular comment, the model application module 206 selects one and assigns it to the comment. For instance, the model application module 206 selects the classification with the highest confidence score. In other embodiments, two or more classifications can be assigned to the comment, for example, if the confidence scores for the classifications are the same or similar (e.g., within a threshold difference value). In certain embodiments, the model application module 206 assigns one or more classifications to a comment only if one or more confidence scores associated with the one or more classifications satisfy a threshold level of confidence.

In some embodiments, the model application module 206 may output all classifications in a set of possible classifications and their associated confidence scores. In some cases, page administrators, administrators of the social networking system, or other personnel may want to know the confidence scores for all classifications that are available. In one example, for the comment “I bought this and didn't like it,” the model application module 206 may output the following classifications and their associated confidence scores: complaint—99% confidence; compliment—0% confidence. The “compliment” classification and the associated confidence score are provided to the page administrators, the administrators of the social networking system, or the other personnel even if the likelihood of the “compliment” classification being assigned to the comment is very low. All examples herein are provided for illustrative purposes, and there can be many variations or other possibilities.

In some embodiments, a classification is associated with a comment only if it meets a selected level of confidence. If a confidence score associated with an identified classification for a comment satisfies a threshold value, the identified classification is assigned to the comment. If a confidence score associated with an identified classification for a comment is below a threshold value, the identified classification is not assigned to the comment.

A classification can be displayed through a suitable interface in connection with a comment. For example, the classification is displayed as a tag or label. In one example, a comment assigned the “actionable” classification is displayed with an “actionable” tag or label on or adjacent to the comment. In some embodiments, a classification is displayed only if it meets a selected level of confidence. For instance, the classification is displayed to a page administrator if the confidence score associated with the classification satisfies a threshold value (e.g., greater than, greater than or equal to, etc.). The threshold values may be selected to provide high accuracy. In one example, the threshold value is 90%. In some embodiments, the classification can be displayed with an indication relating to confidence level (e.g., percentage, high/medium/low, etc.). For example, if a confidence score for the classification satisfies the threshold value, the classification may be provided with an indication of high confidence, and if the confidence score for the classification does not satisfies the threshold value, the classification may be provided with an indication of low confidence. In certain embodiments, the classification is displayed in connection with the comment even if the confidence score for the classification does not satisfy a threshold value. In some cases, multiple threshold values may be used for various levels of confidence, and a classification may be provided with an indication associated with a level of confidence for a satisfied threshold value. The threshold values may be determined by the comment ranking module 102 or manually. The threshold values may be selected based on any suitable factors. The threshold values may be selected such that a classification provided to page administrators has a sufficient confidence level to allow page administrators to take action with respect to the comment associated with the classification.

The machine learning models may be adjusted or retrained based on the results of the classifications provided by the models. If the models are not producing the desired classifications for the comments, the training data set may be adjusted as appropriate, and the models can be retrained based on a new training data set. For example, a person can review and validate a classification assigned to a comment by a machine learning model. If the assigned classification does not accurately reflect actionability of the comment or an intent associated with the comment, the person can assign an appropriate classification to the comment. The machine learning model can be retrained based on comments with adjusted classifications.

In one embodiment, the classification is determined by also considering the content of adjacent comments. In some cases, it may be difficult for the machine learning models to identify a classification based on the text of the comment alone. In such cases, one or more adjacent comments (e.g., associated with the same post) can be provided to the machine learning models, and the models may determine a classification for the comment based on the text of the adjacent comments.

Various features can be implemented in association with classifications. For example, page administrators can tailor the present technology according to the preferences or requirements of their pages. In certain embodiments, page administrators may also be able to define their own classifications, and the machine learning models may classify comments based on the classifications defined by the page administrators, for example, in addition to system provided classifications. Individualized machine learning models may be provided for different pages. In some embodiments, the page administrator may have the option to provide automated responses to particular comments based on classifications determined for the comments. For instance, the page administrator can define an automated response to be provided for a comment associated with a particular classification (e.g., whether system provided or administrator defined). In certain embodiments, the page administrators can receive notifications relating to particular classifications associated with comments, for example, by email, text, phone call, etc. In an embodiment, advertisements can be provided to users who visit a page based on classifications associated with comments submitted by the users to the page.

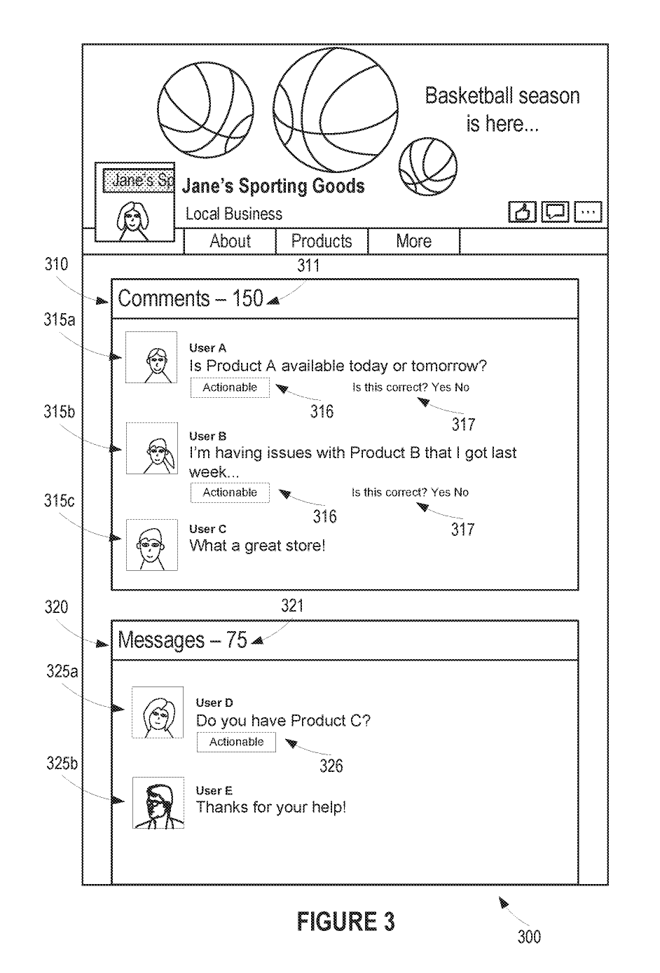

FIG. 3 illustrates an example user interface 300 for providing comments and associated classifications, according to an embodiment of the present disclosure. The user interface 300 illustrates a page associated with a business for illustrative purposes, but the techniques described in this disclosure can be used with any type of page. A section 310 can display comments 315 submitted to the page by users. A section 320 can display messages 325 sent to the page by users.

The section 310 can display recent comments 315a, 315b, 315c received by the page. The section 310 can indicate the number of new comments 311. A comment 315a, 315b, 315c can be displayed with an indication of a classification associated with the comment. For example, an indication of a classification can be displayed if the confidence level for the classification satisfies a threshold. As explained above, the indication of the classification can be provided as a tag or label 316. In some cases, the indication of the classification can be provided using a different color or in other distinguishing ways. In the example of FIG. 3, a comment from User A 315a and a comment from User B 315b are displayed with an “actionable” tag or label 316. Comments with indications of classifications can be displayed with more visibility than comments without indications of classifications. For example, comments 315a, 315b with indications of classifications can be shown at the top of the section 310. Or comments 315a, 315b with indications of classifications can be shown in a more noticeable color compared to comment 315c without indications of classifications. A page administrator can click on a comment 315a, 315b, 315c, and the user interface 300 can display a tool for managing comments that can display all comments for the page (not shown). The tool for managing comments can display comments with indications of classifications at the top such that the page administrator can quickly find and view comments that require action. Comments with indications of classifications can be displayed in a manner that distinguishes them from comments without indications of classifications. For example, comments with indications of classifications and comments without indications of classifications can be distinguished based on a position of display within the user interface 300, text color, text style, etc.

The section 320 can display messages 325 sent to the page by users. The section 320 can display recent messages 325a, 325b received by the page. The section 320 can indicate the number of new messages 321. A message can be also be displayed with an indication of a classification associated with the message. Similar to comments, the indication of the classification for a message can be provided as a tag or label. In the example of FIG. 3, a message from User D 325a is displayed with a tag or label 326.

In some cases, the classification provided for a comment may not accurately reflect actionability of the comment or an intent associated with the comment, and the user interface 300 can provide a mechanism for a page administrator to provide feedback regarding whether a classification associated with a comment is correct. For example, the section 310 or the tool for managing comments can display a question 317 “Is this correct” for a comment 315, and the page administrator can click “Yes” or “No.” Information from page administrators regarding correctness of classifications reflected by indications of classifications (e.g., tags, labels, etc.) may be used to train and retrain the machine learning models. In some embodiments, the mechanism for feedback can be provided in the tool for managing comments.

In some embodiments, page administrators can search for comments that are assigned a particular classification. For instance, the user interface 300 can include a keyword search utility based on classifications (not shown). The page administrator may perform a keyword search by typing in a keyword search bar a keyword for a specific classification or by selecting a classification from a dropdown menu. Comments that have been assigned the classification associated with the entered keyword or the selected classification may be returned for display in the user interface 300. All examples herein are provided for illustrative purposes, and there can be many variations or other possibilities.

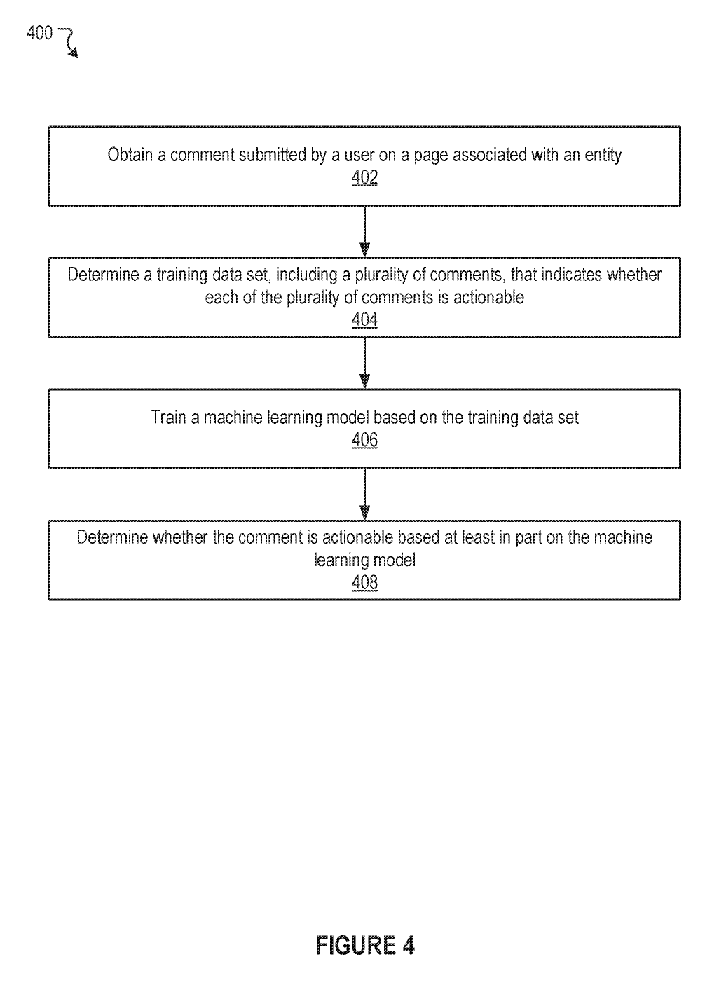

FIG. 4 illustrates an example first method 400 for determining classification for comments for pages, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can obtain a comment submitted by a user on a page associated with an entity. The page can be provided by a social networking system. At block 404, the example method 400 can determine a training data set, including a plurality of comments, that indicates whether each of the plurality of comments is actionable. At block 406, the example method 400 can train a machine learning model based on the training data set. At block 408, the example method 400 can determine whether the comment is actionable based at least in part on the machine learning model. Other suitable techniques that incorporate various features and embodiments of the present technology are possible.

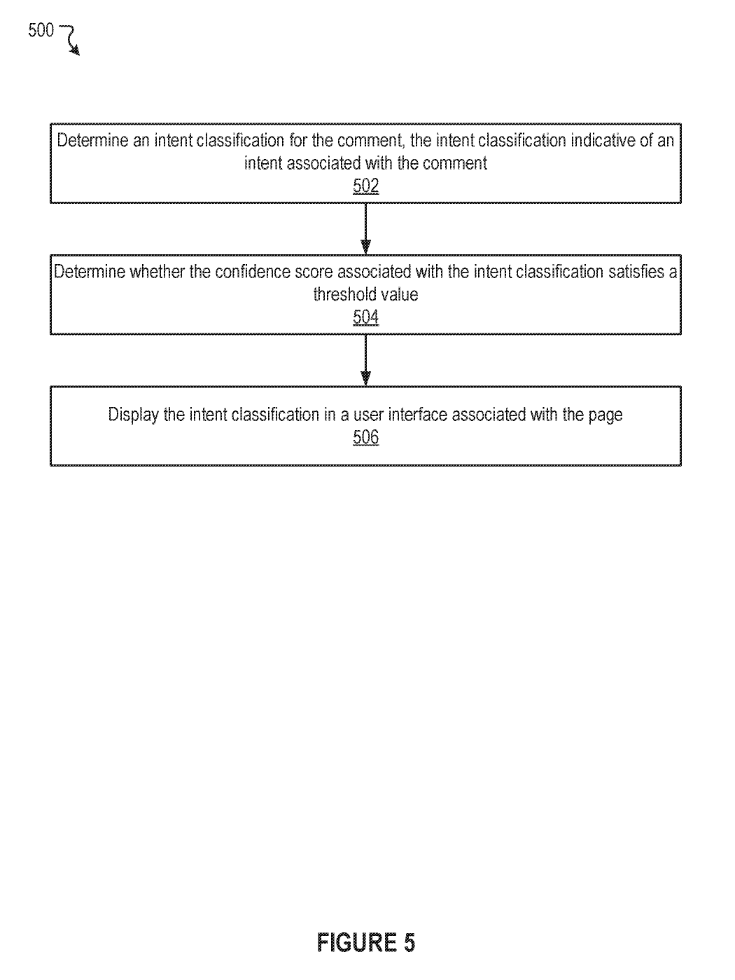

FIG. 5 illustrates an example second method 500 for determining classification for comments for pages, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can determine an intent classification for the comment. The intent classification can be indicative of an intent associated with a comment. The comment can be similar to the comment explained in connection with FIG. 4. At block 504, the example method 500 can determine whether the confidence score associated with the intent classification satisfies a threshold value. At block 506, the example method 500 can display the intent classification in a user interface associated with the page, for example, in response to determining that the confidence score associated with the first classification satisfies the threshold value. The page can be similar to the page explained in connection with FIG. 4. Other suitable techniques that incorporate various features and embodiments of the present technology are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a comment ranking module 646. The comment ranking module 646 can, for example, be implemented as the comment ranking module 102, as discussed in more detail herein. As discussed previously, it should be appreciated that there can be many variations or other possibilities. For example, in some embodiments, one or more functionalities of the comment ranking module 646 can be implemented in the user device 610.

### Hardware Implementation

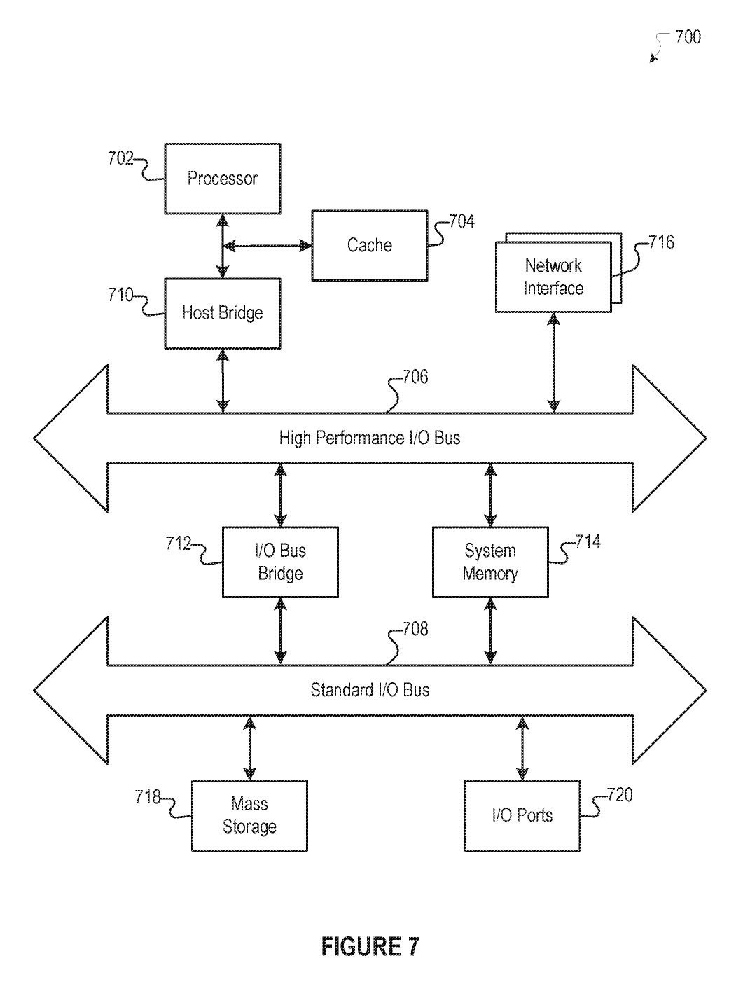

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a computing system, a comment submitted by a user on a page associated with an entity;
determining, by the computing system, a training data set, including a plurality of comments, that indicates whether each of the plurality of comments is actionable;
training, by the computing system, a machine learning model based on the training data set; and
determining, by the computing system, whether the comment is actionable based at least in part on the machine learning model.

2. The computer-implemented method of claim 1, wherein the determining whether the comment is actionable comprises associating the comment with a first classification in response to determining that the comment is actionable, the first classification indicative of a comment being actionable.

3. The computer-implemented method of claim 2, wherein the machine learning model provides the first classification and a confidence score associated with the first classification.

4. The computer-implemented method of claim 3, wherein the first classification is associated with the comment when the confidence score associated with the first classification satisfies a threshold value.

5. The computer-implemented method of claim 3, further comprising displaying the first classification in a user interface associated with the page when the confidence score associated with the first classification satisfies a threshold value.

6. The computer-implemented method of claim 2, further comprising receiving user input relating to whether the first classification is correct.

7. The computer-implemented method of claim 2, wherein a comment that is actionable in the training data set is associated with the first classification.

8. The computer-implemented method of claim 2, wherein the determining the training data set comprises performing a pattern search on one or more comments using one or more regular expressions, wherein each of the one or more regular expressions is associated with the first classification, and wherein a comment of the one or more comments that includes text matching at least one of the one or more regular expressions is associated with the first classification and included in the training data set.

9. The computer-implemented method of claim 2, wherein the determining the training data set comprises obtaining one or more comments that are associated with the first classification based at least in part on human input.

10. The computer-implemented method of claim 1, further comprising determining an intent classification for the comment, the intent classification indicative of an intent associated with a comment.

11. A system comprising:
at least one hardware processor; and
a memory storing instructions that, when executed by the at least one processor, cause the system to perform:
obtaining a comment submitted by a user on a page associated with an entity;
determining a training data set, including a plurality of comments, that indicates whether each of the plurality of comments is actionable;
training a machine learning model based on the training data set; and
determining whether the comment is actionable based at least in part on the machine learning model.

12. The system of claim 11, wherein the determining whether the comment is actionable comprises associating the comment with a first classification in response to determining that the comment is actionable, the first classification indicative of a comment being actionable.

13. The system of claim 12, wherein the machine learning model provides the first classification and a confidence score associated with the first classification.

14. The system of claim 13, wherein the first classification is associated with the comment when the confidence score associated with the first classification satisfies a threshold value.

15. The system of claim 13, wherein the instructions further cause the system to perform displaying the first classification in a user interface associated with the page when the confidence score associated with the first classification satisfies a threshold value.

16. A non-transitory computer readable medium including instructions that, when executed by at least one hardware processor of a computing system, cause the computing system to perform a method comprising:
obtaining a comment submitted by a user on a page associated with an entity;
determining a training data set, including a plurality of comments, that indicates whether each of the plurality of comments is actionable;
training a machine learning model based on the training data set; and
determining whether the comment is actionable based at least in part on the machine learning model.

17. The non-transitory computer readable medium of claim 16, wherein the determining whether the comment is actionable comprises associating the comment with a first classification in response to determining that the comment is actionable, the first classification indicative of a comment being actionable.

18. The non-transitory computer readable medium of claim 17, wherein the machine learning model provides the first classification and a confidence score associated with the first classification.

19. The non-transitory computer readable medium of claim 18, wherein the first classification is associated with the comment when the confidence score associated with the first classification satisfies a threshold value.

20. The non-transitory computer readable medium of claim 18, wherein the method further comprises displaying the first classification in a user interface associated with the page when the confidence score associated with the first classification satisfies a threshold value.
